(19) United States
(12) Patent Application Publication
(10) Pub. No.: US 2023/0055138 A1
(43) Pub. Date: Feb. 23, 2023

(54) UTILIZING MACHINE LEARNING MODELS TO GENERATE AND MONITOR PROGRESS OF A STRATEGIC PLAN

(71) Applicant: Accenture Global Solutions Limited, Dublin (IE)

(72) Inventors: Aditi KULKARNI, Bangalore (IN); Koushik M VIJAYARAGHAVAN, Chennai (IN); Rajesh NAGARAJAN, Chennai (IN); Sangeeta S IYER, Bangalore (IN); Pratap VENKATA NAGA POORNA BONTHA, Hyderabad (IN); Ruchi MARWAHA, Bangalore (IN); Chaitra HEBBAL, Bangalore (IN); Mahatma Reddy KIKKURI, Hyderabad (IN); Parul JAGTAP, DELHI (IN)

(21) Appl. No.: 17/407,801

(22) Filed: Aug. 20, 2021

(51) Int. Cl. G06Q 10/06; G06F 40/186; G06N 20/20

(52) U.S. Cl. CPC G06Q 10/0637; G06F 40/186; G06N 20/20

(57) ABSTRACT

A device may receive entity data identifying an entity and may identify harvested templates, contract profiles, and commitment accuracy scores, based on the entity data. The device may process the harvested templates, the contract profiles, and the commitment accuracy scores, with a first machine learning model, to generate first templates and may process the harvested templates, the contract profiles, and the commitment accuracy scores, with a second machine learning model, to generate second templates. The device may process the first templates and the second templates, with a third machine learning model, to generate final templates and final rankings for the final templates and may select a template from the final templates based on the final rankings. The device may process the template, with a fourth machine learning model, to identify deliverables associated with the template and may generate and implement a strategic plan based on the template and the deliverables.

### BACKGROUND

Strategic planning is an entity's (e.g., an organization's) process of defining a strategy, or a direction, and making decisions on allocating resources to pursue the strategy. Strategic planning may also extend to control mechanisms for guiding implementation of the strategy.

### SUMMARY

Some implementations described herein relate to a method. The method may include receiving entity data identifying an entity associated with generating and implementing a strategic plan, and identifying harvested templates, contract profiles, and commitment accuracy scores associated with strategic plans, based on the entity data. The method may include processing the harvested templates, the contract profiles, and the commitment accuracy scores, with a first machine learning model, to generate a first plurality of templates, and processing the harvested templates, the contract profiles, and the commitment accuracy scores, with a second machine learning model, to generate a second plurality of templates. The method may include processing the first plurality of templates and the second plurality of templates, with a third machine learning model, to generate a final plurality of templates and final rankings for the final plurality of templates, and selecting a template from the final plurality of templates based on the final rankings. The method may include processing the template, with a fourth machine learning model, to identify deliverables associated with the template, and generating a strategic plan based on the template and the deliverables. The method may include causing the strategic plan to be implemented.

Some implementations described herein relate to a device. The device may include one or more memories and one or more processors coupled to the one or more memories. The one or more processors may be configured to receive entity data identifying an entity associated with generating and implementing a strategic plan, and identify harvested templates, contract profiles, and commitment accuracy scores associated with strategic plans, based on the entity data. The one or more processors may be configured to process the harvested templates, the contract profiles, and the commitment accuracy scores, with a first machine learning model, to generate a first plurality of templates, and process the harvested templates, the contract profiles, and the commitment accuracy scores, with a second machine learning model, to generate a second plurality of templates. The one or more processors may be configured to process the first plurality of templates and the second plurality of templates, with a third machine learning model, to generate a final plurality of templates and final rankings for the final plurality of templates, and select a template from the final plurality of templates based on the final rankings. The one or more processors may be configured to process the template, with a fourth machine learning model, to identify deliverables associated with the template, and generate a strategic plan based on the template and the deliverables. The one or more processors may be configured to cause the strategic plan to be implemented, and track the progress of implementation of the strategic plan.

Some implementations described herein relate to a non-transitory computer-readable medium that stores a set of instructions for a device. The set of instructions, when executed by one or more processors of the device, may cause the device to receive entity data identifying an entity associated with generating and implementing a strategic plan, and identify harvested templates, contract profiles, and commitment accuracy scores associated with strategic plans, based on the entity data. The set of instructions, when executed by one or more processors of the device, may cause the device to process the harvested templates, the contract profiles, and the commitment accuracy scores, with a first machine learning model, to generate a first plurality of templates, and process the harvested templates, the contract profiles, and the commitment accuracy scores, with a second machine learning model, to generate a second plurality of templates. The set of instructions, when executed by one or more processors of the device, may cause the device to process the first plurality of templates and the second plurality of templates, with a third machine learning model, to generate a final plurality of templates and final rankings for the final plurality of templates, and select a template from the final plurality of templates based on the final rankings. The set of instructions, when executed by one or more processors of the device, may cause the device to process the template, with a fourth machine learning model, to identify deliverables associated with the template, and generate a strategic plan based on the template and the deliverables. The set of instructions, when executed by one or more processors of the device, may cause the device to cause the strategic plan to be implemented, and utilize a fifth machine learning model, with the strategic plan and progress data identifying progress of implementation of the strategic plan, to identify milestone delays. The set of instructions, when executed by one or more processors of the device, may cause the device to utilize a sixth machine learning model, with the milestone delays, to generate one or more recommendations to mitigate the milestone delays, and cause the one or more recommendations to be implemented.

### BRIEF DESCRIPTION OF THE DRAWINGS

FIGS. 1A-1G are diagrams of an example implementation described herein.

FIG. 2 is a diagram illustrating an example of training and using a machine learning model in connection with generating and monitoring progress of a strategic plan.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing machine learning models to generate and monitor progress of a strategic plan.

### DETAILED DESCRIPTION

The following detailed description of example implementations refers to the accompanying drawings. The same reference numbers in different drawings may identify the same or similar elements.

Strategic planning requires generating a roadmap or a strategic plan. A strategic plan is typically generated using a variety of word processing, presentation, and/or spreadsheet documents that are offline documents. These offline documents often need to be revisited, reworked, and/or updated multiple times until the strategic plan is implemented. Further, the strategic plan must be broken down for day-to-day planning, and insights must be derived to help implement the strategic plan. Such a process requires considerable time and resources to generate the offline documents, revise the offline documents, implement the strategic plan based on the offline document, correct a defective strategic plan after implementation, and/or the like. Therefore, current techniques for generating a strategic plan consume computing resources (e.g., processing resources, memory resources, communication resources, and/or the like), networking resources, and/or the like associated with generating defective strategic plans, losing opportunities for the business based on the defective strategic plans, correcting the defective strategic plans, and/or the like.

Some implementations described herein relate to a planning system that utilizes machine learning models to generate and monitor progress of a strategic plan. For example, the planning system may receive entity data identifying an entity associated with generating and implementing a strategic plan, and may identify harvested templates, contract profiles, and commitment accuracy scores associated with strategic plans, based on the entity data. The planning system may process the harvested templates, the contract profiles, and the commitment accuracy scores, with a first machine learning model, to generate a first plurality of templates, and may process the harvested templates, the contract profiles, and the commitment accuracy scores, with a second machine learning model, to generate a second plurality of templates. The planning system may process the first plurality of templates and the second plurality of templates, with a third machine learning model, to generate a final plurality of templates and final rankings for the final plurality of templates, and may select a template from the final plurality of templates based on the final rankings. The planning system may process the template, with a fourth machine learning model, to identify deliverables associated with the template, and may generate a strategic plan based on the template and the deliverables. The planning system may cause the strategic plan to be implemented.

In this way, the planning system utilizes machine learning models to generate and monitor progress of a strategic plan. The planning system may align an entity's vision, a strategic plan, and execution of the strategic plan with embedded intelligence. The planning system may create a strategic plan for an entity and may track progress of implementation of the strategic plan in real-time. The planning system may subsequently transform the strategic plan into a delivery plan and may generate machine learning model-based insights and predictive metrics to help track day-to-day progress of the delivery plan. This, in turn, conserves computing resources, networking resources, and/or the like that would otherwise have been consumed in generating defective or inoperable strategic plans, losing opportunities for the business based on the defective or inoperable strategic plans, correcting the defective strategic plans, and/or the like.

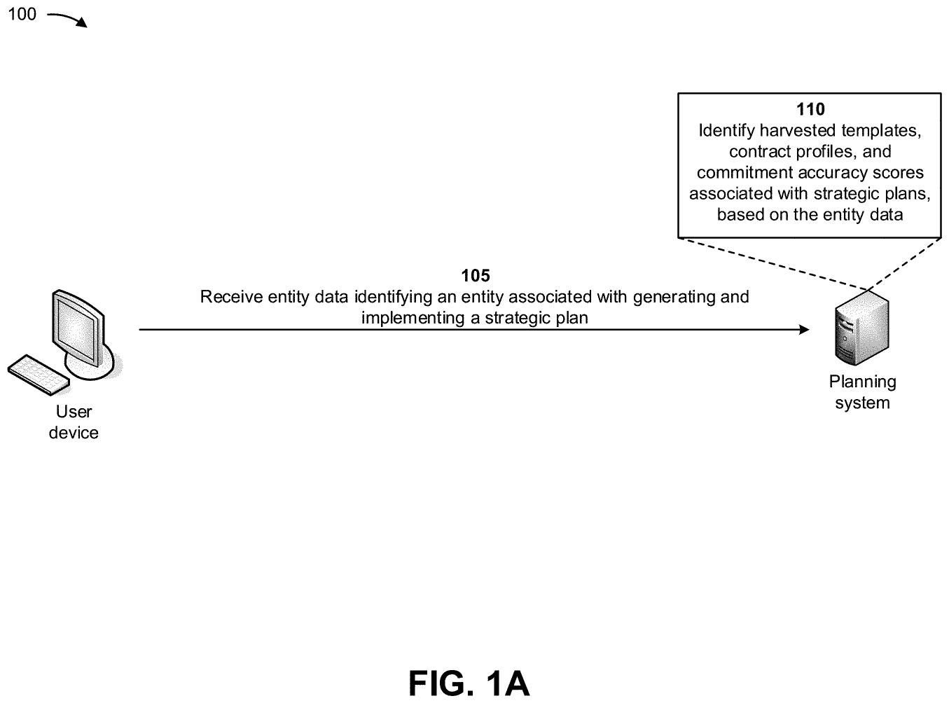

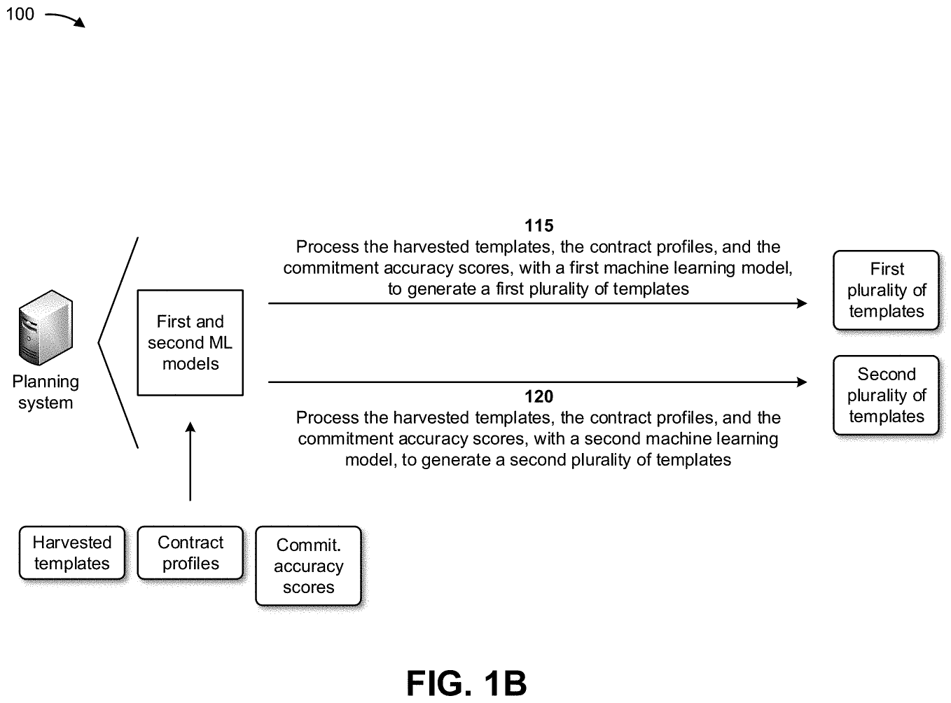

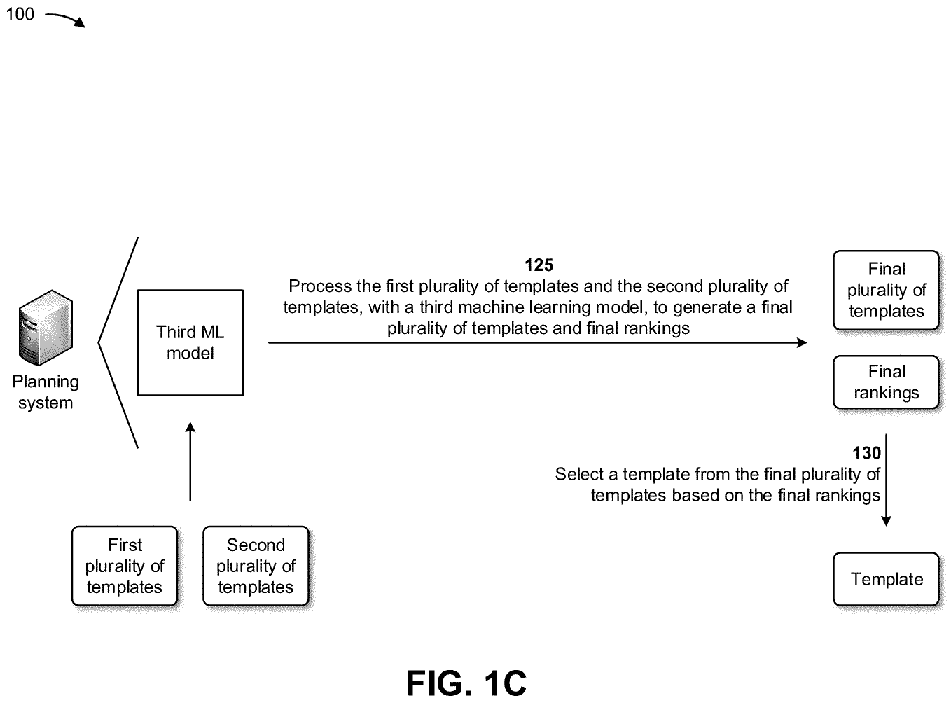

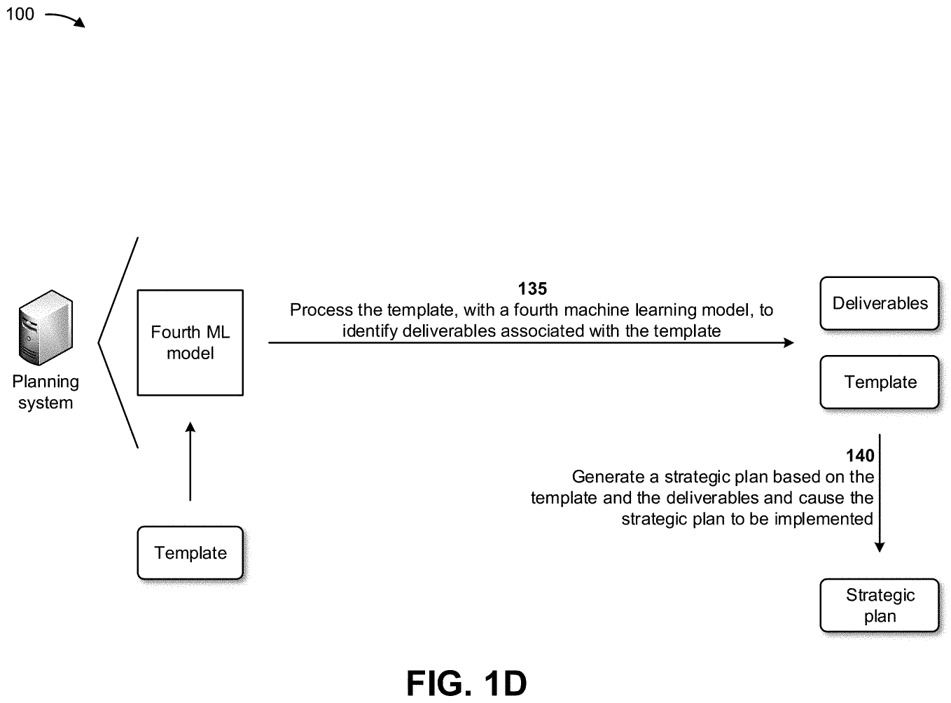

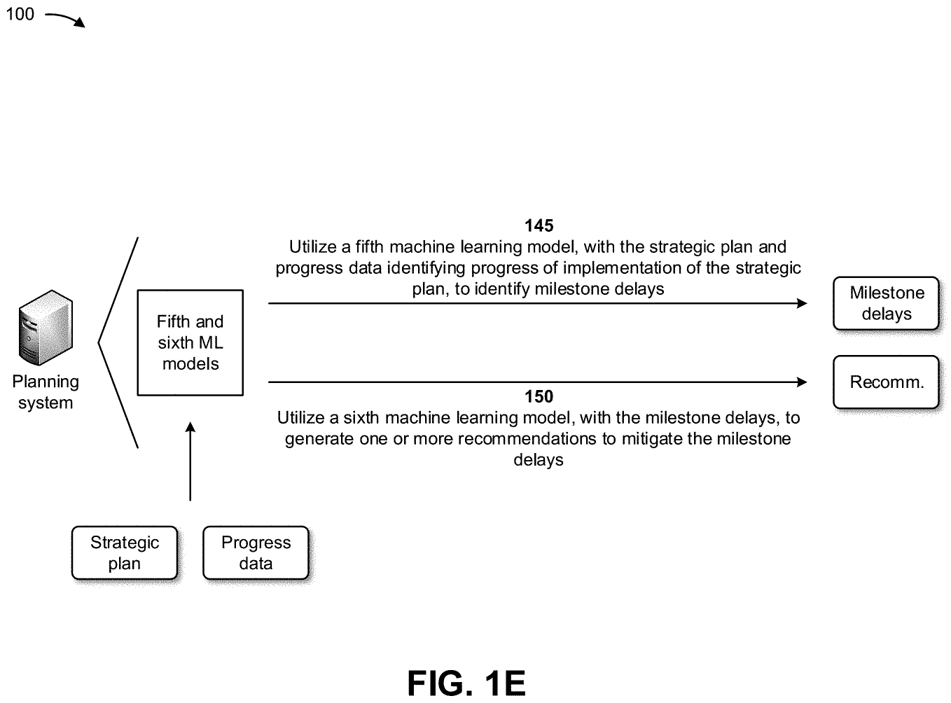

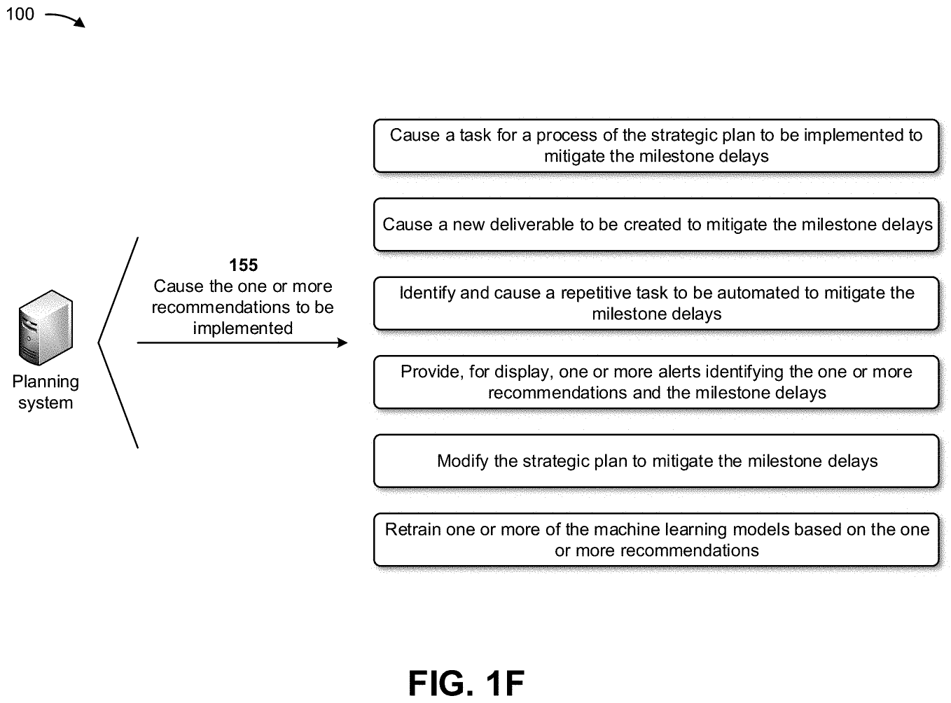

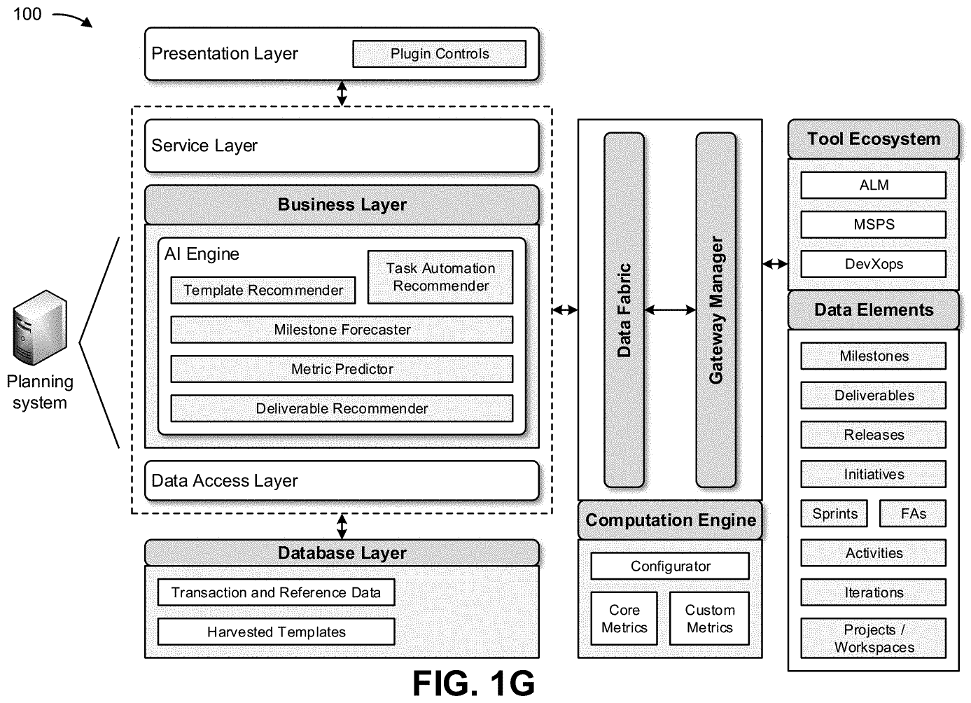

FIGS. 1A-1G are diagrams of an example 100 associated with utilizing machine learning models to generate and monitor progress of a strategic plan. As shown in FIGS. 1A-1G, example 100 includes a user device and a planning system. The user device may include a wireless communication device, a mobile phone, a user equipment, a laptop computer, a tablet computer, and/or the like. The planning system may include a system that utilizes machine learning models to generate and monitor progress of a strategic plan. Further details of the user device and the planning system are provided elsewhere herein.

As shown in FIG. 1A, and by reference number 105, the planning system may receive entity data identifying an entity associated with generating and implementing a strategic plan. For example, a user may cause the user device to provide the entity data to the planning system, and the planning system may receive the entity data from the user device. The entity may include a business, an organization, an agency, and/or the like. The entity data may include data identifying the entity, demographics of the entity, tools utilized by the entity, an industry associated with the entity, contracts associated with the industry and/or the entity, strategic plans associated with the industry and/or the entity, commitment scores associated with the industry and/or the entity, an application lifecycle management (ALM) ecosystem of the entity, delivery details associated with the strategic plan of the entity, a contract size associated with the strategic plan of the entity, a type of project associated with the strategic plan of the entity, a template success rate associated with the entity, a sub-industry associated with the entity, ALM tools utilized by the entity, a capability maturity model integration (CMMI) level associated with the entity, technology associated with the entity, and/or the like.

As further shown in FIG. 1A, and by reference number 110, the planning system may identify harvested templates, contract profiles, and commitment accuracy scores associated with strategic plans, based on the entity data. For example, the planning system may be associated with a data structure (e.g., a database, a table, a list, and/or the like) that stores a plurality of templates harvested from strategic planning processes of various industries, a plurality of contract profiles associated with the plurality of templates, a plurality of commitment accuracy scores associated with the plurality of contract profiles, and/or the like. The planning system may compare the entity data with the data stored in the data structure to identify the harvested templates, the contract profiles, and the commitment accuracy scores from the plurality of templates, the plurality of contract profiles associated with the plurality of templates, the plurality of commitment accuracy scores associated with the plurality of contract profiles, and/or the like stored in the data structure. The harvested templates may include strategic planning processes of various industries and/or of an industry associated with the entity. The contract profiles may include data identifying contracts associated with the harvested templates. The commitment accuracy scores may indicate successfulness indices of the contracts associated with the harvested templates.

As shown in FIG. 1B, and by reference number 115, the planning system may process the harvested templates, the contract profiles, and the commitment accuracy scores, with a first machine learning model, to generate a first plurality of templates. For example, when processing the harvested templates, the contract profiles, and the commitment accuracy scores, with the first machine learning model, to generate the first plurality of templates, the planning system may match common factors between the harvested templates, the contract profiles, and the commitment accuracy scores, and may generate the first plurality of templates based on matching the common factors between the harvested templates, the contract profiles, and the commitment accuracy scores. In some implementations, the first machine learning model includes a decision tree and dot product model. In some implementations, the first machine learning model sorts the first plurality of templates based on contextual ranks of the first plurality of templates (e.g., as determined based on matching the common factors).

The planning system may provide the harvested templates, the contract profiles, the commitment accuracy scores, and influence data to the first machine learning model, and the first machine learning model may generate the first plurality of templates based on the harvested templates, the contract profiles, the commitment accuracy scores, and the influence data. The influence data may include data identifying the demographics of the entity, the ALM ecosystem of the entity, the delivery details associated with the strategic plan of the entity, the contract size associated with the strategic plan of the entity, the type of project associated with the strategic plan of the entity, the template success rate associated with the entity, the industry and/or sub-industry associated with the entity, the ALM tools utilized by the entity, the CMMI level associated with the entity, the technology associated with the entity, and/or the like. In one example, when generating the first plurality of templates, the first machine learning model may utilize the following dot product:

$$a \cdot b = {\sum }_{i = 1}^{n} {a}_{i} {b}_{i}$$

where a corresponds to a first vector (e.g., the harvested templates), b corresponds to a second vector (e.g., the contract profiles), n corresponds to a dimension of a vector space, a, corresponds to a component of vector a, and bᵢ corresponds to a component of vector b.

As further shown in FIG. 1B, and by reference number 120, the planning system may process the harvested templates, the contract profiles, and the commitment accuracy scores, with a second machine learning model, to generate a second plurality of templates. For example, when processing the harvested templates, the contract profiles, and the commitment accuracy scores, with the second machine learning model, to generate the second plurality of templates, the planning system may analyze usage patterns associated with the contract profiles, and may generate the second plurality of templates based on analyzing the usage patterns associated with the contract profiles. In some implementations, the second machine learning model includes a singular value decomposition (SVD) and matrix factorization model. In some implementations, the second machine learning model sorts the second plurality of templates based on usage ranks of the second plurality of templates (e.g., as determined based on analyzing the usage patterns).

The planning system may provide the harvested templates, the contract profiles, the commitment accuracy scores, and usage data to the second machine learning model, and the second machine learning model may generate the second plurality of templates based on the harvested templates, the contract profiles, the commitment accuracy scores, and the usage data. The usage data may include data identifying latent factors based on underlying template usage patterns of the contract profiles, contract choices, template relevance, and/or the like. In one example, the second machine learning model may utilize matrix factorization to decompose a base matrix into a product of two lower-dimensional matrices. The matrix factorization may determine the usage patterns and the latent factors which, when combined, form the base matrix, according to the following equation.

$$Predicted Matrix ( Contracts \times Templates ) =$$

$$Matrix A ( Templates \times Latent factors ) * \\ Matrix B ( Contracts \times Latent factors ) .$$

Where the Predicted Matrix corresponds to a matrix of the contract profiles and the harvested templates, Matrix A corresponds to a matrix of the harvested templates and the latent factors, and Matrix B corresponds to a matrix of the contract profiles and the latent factors.

As shown in FIG. 1C, and by reference number 125, the planning system may process the first plurality of templates and the second plurality of templates, with a third machine learning model, to generate a final plurality of templates and final rankings. For example, when processing the first plurality of templates and the second plurality of templates, with the third machine learning model, to generate the final plurality of templates and the final rankings for the final plurality of templates, the planning system may utilize stacked generalization to combine the first plurality of templates and the second plurality of templates, and may generate the final plurality of templates and the final rankings for the final plurality of templates based on utilizing the stacked generalization to combine the first plurality of templates and the second plurality of templates. In some implementations, the third machine learning model includes a stacked generalization model. In some implementations, the third machine learning model combines the first plurality of templates and the second plurality of templates to ensure that the final plurality of templates represents both the first plurality of templates and the second plurality of templates to provide the final rankings.

The third machine learning model may determine how to best combine the predictions from the first machine learning model (e.g., the first plurality of templates) and the second machine learning model (e.g., the second plurality of templates) to generate the final plurality of templates and the final rankings. For example, the third machine learning model receives the first plurality of templates and the second plurality of templates as inputs and determines how to best combine the inputs to generate an optimal output prediction (e.g., the final plurality of templates and the final rankings).

As further shown in FIG. 1C, and by reference number 130, the planning system may select a template from the final plurality of templates based on the final rankings. For example, the planning system may select one of the final plurality of templates with a greatest final ranking as the template. In some implementations, the planning system may select more than one template from the final plurality of templates based on the final rankings when more than one strategic plan is to be generated for the entity. For example, the entity may wish to evaluate multiple strategic plans, and the planning system may select more than one template from the plurality of templates based on the entity wishing to evaluate multiple strategic plans.

As shown in FIG. 1D, and by reference number 135, the planning system may process the template, with a fourth machine learning model, to identify deliverables associated with the template. For example, when processing the template, with the fourth machine learning model, to identify the deliverables associated with the template, the planning system may determine an entity contract profile based on the entity data, and may combine the entity contract profile, the template, and a deliverable knowledge data structure to identify the deliverables associated with the template. Since not all contract delivery is straightforward and every contract includes expertise and a mode of custom delivery (e.g., deliverables), the planning system may utilize the fourth machine learning model to determine high-level road mapping goals and objectives of the entity, and to determine the entity contract profile based on the high-level road mapping goals and objectives. The planning system may utilize the fourth machine learning model to combine the template, the entity contract profile base, and deliverable data stored in the deliverable knowledge data structure when identifying the deliverables associated with the template. In some implementations, the fourth machine learning model includes a cosine similarity and similarity index model. In one example, the cosine similarity and similarity index model may determine a similarity between a first matrix (A) (e.g., the entity contract profile data in matrix form) and a second matrix (B) (e.g., the deliverable data in matrix form) according to the following equation:

$$similarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} .$$

As further shown in FIG. 1D, and by reference number 140, the planning system may generate a strategic plan based on the template and the deliverables, and may cause the strategic plan to be implemented. For example, the planning system may generate the strategic plan based on the strategic planning processes included in the template and based on populating the strategic planning processes with the deliverables. In some implementations, when generating the strategic plan based on the template and the deliverables, the planning system may apply the deliverables to the template to generate the strategic plan. The planning system may cause the strategic plan to be implemented by causing one or more devices and/or systems, associated with the entity, to implement the strategic planning processes populated with the deliverables. Alternatively, the planning system may provide, to the one or more devices and/or systems associated with the entity, the strategic plan and instructions to implement the strategic plan. The one or more devices and/or systems associated with the entity may implement the strategic plan based on the instructions.

As shown in FIG. 1E, and by reference number 145, the planning system may utilize a fifth machine learning model, with the strategic plan and progress data identifying progress of implementation of the strategic plan, to identify milestone delays. For example, the planning system may utilize the fifth machine learning model to monitor progress of implementation of the strategic plan and to identify any potential milestone delays in the implementation. In some implementations, the fifth machine learning model includes a regression model that is trained with historical progress data that includes data identifying tasks, milestones, deliverables, releases, sprints, resources, and/or the like. The fifth machine learning model may include an active learning component to ensure that the identified milestone delays are relevant to context. When identifying the milestone delays, the fifth machine learning model may utilize influence data that may potentially cause a milestone delay. The influence data may be treated as dependent variables when training the fifth machine learning model. The influence data may include data identifying inaccurate estimation of efforts, scope creep in a requirement, external dependencies, skillset mismatch of resources, unplanned leaves of the resources, budget issues, deliverables progress, resource usage, requirement scoping, and/or the like. The influence data may aid the fifth machine learning model in identifying error rates, failed deployments, automated test-case passes, progress of the deliverables, progress of the milestones, and/or the like. In one example, the milestone delay (Y) may be identified based on the following equation:

Y=bias+p₁(x₁)+p₂(x₂)+p₃(x₃)+pₙ(xₙ)

where p₁ through pₙ correspond to parameters and/or coefficients and x₁ through xₙ correspond to features.

As further shown in FIG. 1E, and by reference number 150, the planning system may utilize a sixth machine learning model, with the milestone delays, to generate one or more recommendations to mitigate the milestone delays. For example, when utilizing the sixth machine learning model, with the milestone delays, to generate the one or more recommendations to mitigate the milestone delays, the planning system may utilize Euclidean distance measures and the milestone delays to identify similar historic milestone delays and one or more actions taken to mitigate the similar historic milestone delays, and may perform the one or more actions. In some implementations, the sixth machine learning model may utilize contract preferences, historical milestone knowledge, and the milestone delays, to generate the one or more recommendations to mitigate the milestone delays. In some implementations, the sixth machine learning model includes a Euclidean distance and similarity index model. In some implementations, the sixth machine learning model may identify repetitive activities in the implementation of the strategic plan (e.g., which may cause milestone delays) and may automate the repetitive activities to eliminate the milestone delays.

As shown in FIG. 1F, and by reference number 155, the planning system may cause the one or more recommendations to be implemented. In some implementations, causing the one or more recommendations to be implemented includes the planning system causing a task for a key process of the strategic plan to be implemented to mitigate the milestone delays. For example, the planning system may identify the key process of the strategic plan and may determine that the task may decrease a time required to perform the key process. The planning system may modify the key process to include the task so that the one or more milestone delays may be mitigated. In this way, the planning system conserves computing resources, networking resources, and/or the like that would otherwise have been consumed in generating a delayed strategic plan, losing opportunities for the business based on the delayed strategic plan, and/or the like.

In some implementations, causing the one or more recommendations to be implemented includes the planning system causing a new deliverable to be created to mitigate the milestone delays. For example, the planning system may determine that the new deliverable may decrease one or more of the milestone delays. The planning system may create the new deliverable and may cause the new deliverable to be implemented in the strategic plan to mitigate the milestone delays. In this way, the planning system conserves computing resources, networking resources, and/or the like that would otherwise have been consumed in generating a delayed or defective strategic plan, losing opportunities for the business based on the delayed or defective strategic plan, and/or the like.

In some implementations, causing the one or more recommendations to be implemented includes the planning system identifying and causing a repetitive task to be automated to mitigate the milestone delays. For example, the planning system may identify the repetitive task in the implementation of the strategic plan (e.g., which may cause milestone delays) and may automate the repetitive task to eliminate or mitigate the milestone delays. In this way, the planning system conserves computing resources, networking resources, and/or the like that would otherwise have been consumed in generating a delayed strategic plan, unnecessarily performing repetitive tasks, losing opportunities for the business based on the delayed strategic plan, and/or the like.

In some implementations, causing the one or more recommendations to be implemented includes the planning system providing, for display, one or more alerts identifying the one or more recommendations and the milestone delays. For example, the planning system may provide the one or more alerts identifying the one or more recommendations and the milestone delays to the user device and the user device may display the one or more alerts to the user. The user may cause the one or more recommendations to be implemented in order to mitigate the milestone delays. In this way, the planning system conserves computing resources, networking resources, and/or the like that would otherwise have been consumed in generating a delayed or defective strategic plan, losing opportunities for the business based on the delayed or defective strategic plan, and/or the like.

In some implementations, causing the one or more recommendations to be implemented includes the planning system modifying the strategic plan to mitigate the milestone delays. For example, the planning system may identify one or more of the strategic planning processes included in the template, one or more of the deliverables, and/or the like that may mitigate the milestone delays if modified. The planning system may modify the one or more of the strategic planning processes included in the template, the one or more of the deliverables, and/or the like to mitigate the milestone delays. In this way, the planning system conserves computing resources, networking resources, and/or the like that would otherwise have been consumed in generating a delayed or defective strategic plan, losing opportunities for the business based on the delayed or defective strategic plan, and/or the like.

In some implementations, causing the one or more recommendations to be implemented includes the planning system retraining one or more of the machine learning models based on the one or more recommendations. For example, the planning system may utilize the one or more recommendations as additional training data for retraining the one or more machine learning models, thereby increasing the quantity of training data available for training the one or more machine learning models. Accordingly, the planning system may conserve computing resources associated with identifying, obtaining, and/or generating historical data for training the one or more machine learning models relative to other systems for identifying, obtaining, and/or generating historical data for training machine learning models.

FIG. 1G is a diagram depicting an example architecture of the planning system. As shown, the planning system may include a presentation layer, a service layer, a business layer, a data access layer, and a database layer. Interactions between the different layers and components of the layers may be provided via application programming interfaces. The presentation layer may include plugin controls and may interact with the service layer and the user device (e.g., to present information to the user of the user device). The service layer may interact with the presentation layer and the business layer and may provide services for the planning system. The business layer may interact with an artificial intelligence (AI) engine, a computation engine, and a tool ecosystem. The data access layer may enable the business layer to interact with the database layer. The database layer may include a data structure that stores transaction and reference data and the harvested templates.

The AI engine may include a template recommender, a task automation recommender, a milestone forecaster, a metric predictor, and a deliverable recommender. The template recommender may recommend appropriate templates based on a nature of a contract, demographics of the entity, and the tool ecosystem. The task automation recommender may identify repetitive tasks and may recommend automation for the repetitive tasks. The milestone forecaster may determine ongoing delivery progress of a strategic plan, may identify potential milestone delays based on the delivery progress of the strategic plan, and may recommend actions to be taken to mitigate the milestone delays. The metric predictor identifies metrics data across various ALM tools and utilizes the metrics data to track progress of the strategic plan. The deliverable recommender may analyze the templates and may recommend creation of new deliverables at logical checkpoints for efficient delivery tracking.

The computation engine may include a configurator, a core metrics component, and a customer metrics component. The configurator may configure relevant metrics, aggregation levels, thresholds, and other customizations associated with a contract. The core metrics component may provide core metrics utilized by the tool ecosystem. The custom metrics component may provide custom metrics utilized by the tool ecosystem.

The tool ecosystem may support a variety of tools, such as ALM tools, waterfall-centric tools, and/or the like. The data elements (e.g., utilized by the tool ecosystem) may include milestones, deliverables, releases, initiatives, sprints, functional areas (FAs), activities, iterations, projects/workspaces, and/or the like.

In this way, the planning system utilizes machine learning models to generate and monitor progress of a strategic plan. The planning system may align an entity's vision, a strategic plan, and execution of the strategic plan with embedded intelligence. The planning system may create a strategic plan for an entity and may track progress of implementation of the strategic plan in real-time. The planning system may subsequently transform the strategic plan into a delivery plan and may generate machine learning model-based insights and predictive metrics to help track day-to-day progress of the delivery plan. This, in turn, conserves computing resources, networking resources, and/or the like that would otherwise have been consumed in generating defective or inoperable strategic plans, losing opportunities for the business based on the defective or inoperable strategic plans, correcting the defective strategic plans, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

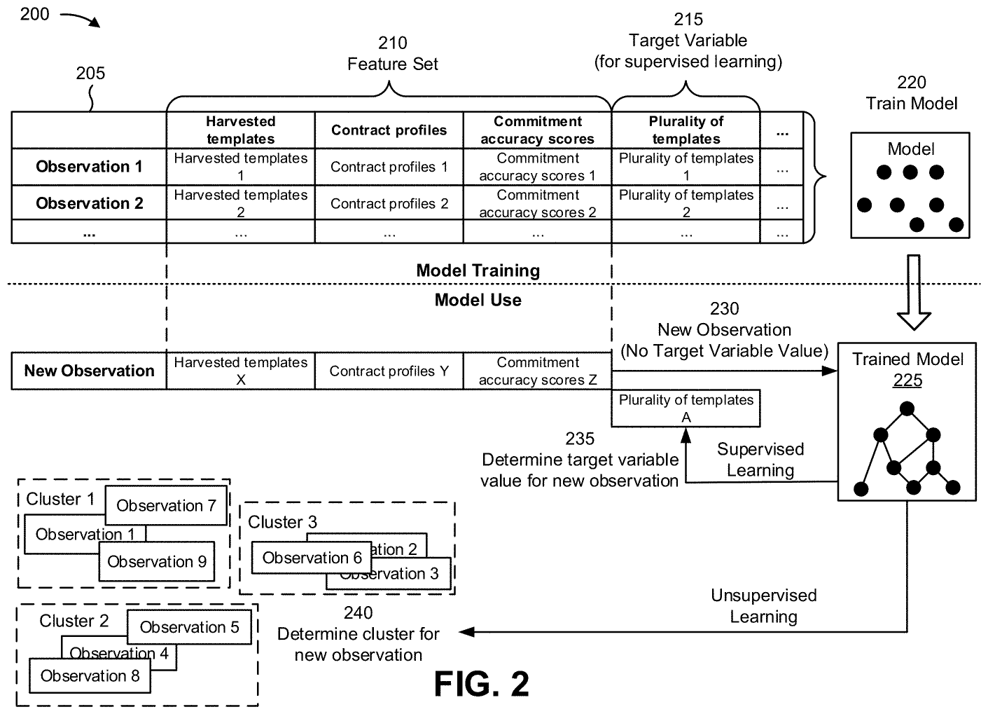

FIG. 2 is a diagram illustrating an example 200 of training and using a machine learning model in connection with generating and monitoring progress of a strategic plan. The machine learning model training and usage described herein may be performed using a machine learning system. The machine learning system may include or may be included in a computing device, a server, a cloud computing environment, and/or the like, such as the planning system described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the planning system, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the planning system. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of harvested templates, a second feature of contract profiles, a third feature of commitment accuracy scores, and so on. As shown, for a first observation, the first feature may have a value of harvested templates 1, the second feature may have a value of contract profiles 1, the third feature may have a value of commitment accuracy scores 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable is a plurality of templates, which has a value of plurality of templates 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of harvested templates X, a second feature of contract profiles Y, a third feature of commitment accuracy scores Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of plurality of templates A for the target variable of the plurality of templates for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a harvested templates cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a contract profiles cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to generating and monitoring progress of a strategic plan. The machine learning system enables recognition and/or identification of tens, hundreds, thousands, or millions of features and/or feature values for tens, hundreds, thousands, or millions of observations, thereby increasing accuracy and consistency and reducing delay associated with generating and monitoring progress of a strategic plan relative to requiring computing resources to be allocated for tens, hundreds, or thousands of operators to manually generate and monitor progress of a strategic plan.

As indicated above, FIG. 2 is provided as an example. Other examples may differ from what is described in connection with FIG. 2.

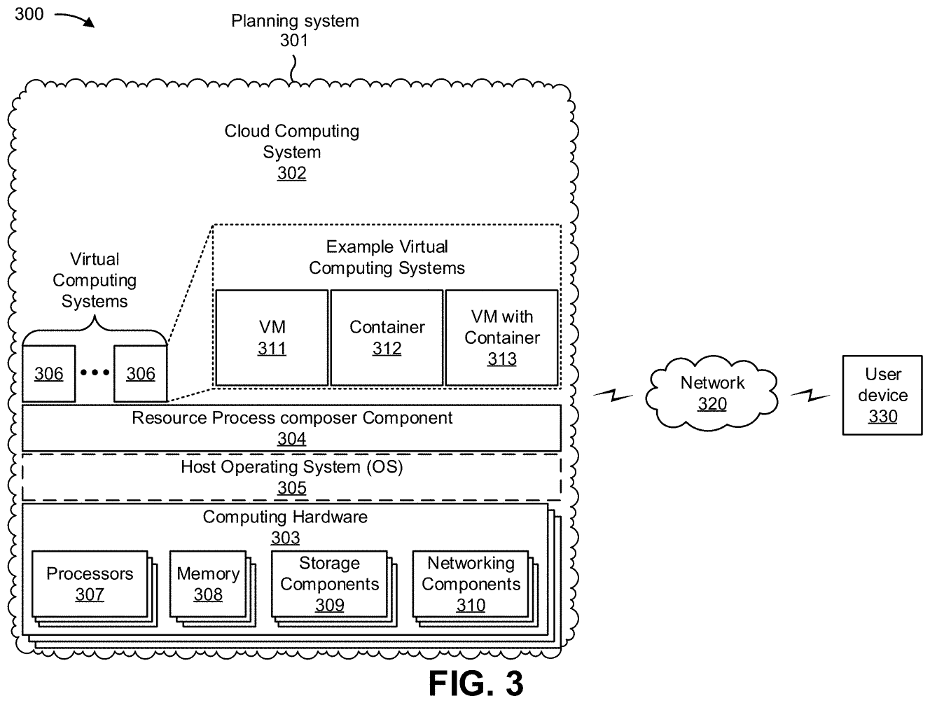

FIG. 3 is a diagram of an example environment 300 in which systems and/or methods described herein may be implemented. As shown in FIG. 3, the environment 300 may include a planning system 301, which may include one or more elements of and/or may execute within a cloud computing system 302. The cloud computing system 302 may include one or more elements 303-313, as described in more detail below. As further shown in FIG. 3, the environment 300 may include a network 320 and/or a user device 330. Devices and/or elements of the environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of the computing hardware 303 to create the one or more virtual computing systems 306. Using virtualization, the resource management component 304 enables a single computing device (e.g., a computer, a server, and/or the like) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing the computing hardware 303 to start, stop, and/or manage the one or more virtual computing systems 306. For example, the resource management component 304 may include a hypervisor (e.g., a bare-metal or Type 1 hypervisor, a hosted or Type 2 hypervisor, and/or the like) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, a hybrid environment 313 that includes a virtual machine and a container, and/or the like. A virtual computing system 306 may execute one or more applications using a file system that includes binary files, software libraries, and/or other resources required to execute applications on a guest operating system (e.g., within the virtual computing system 306) or the host operating system 305.

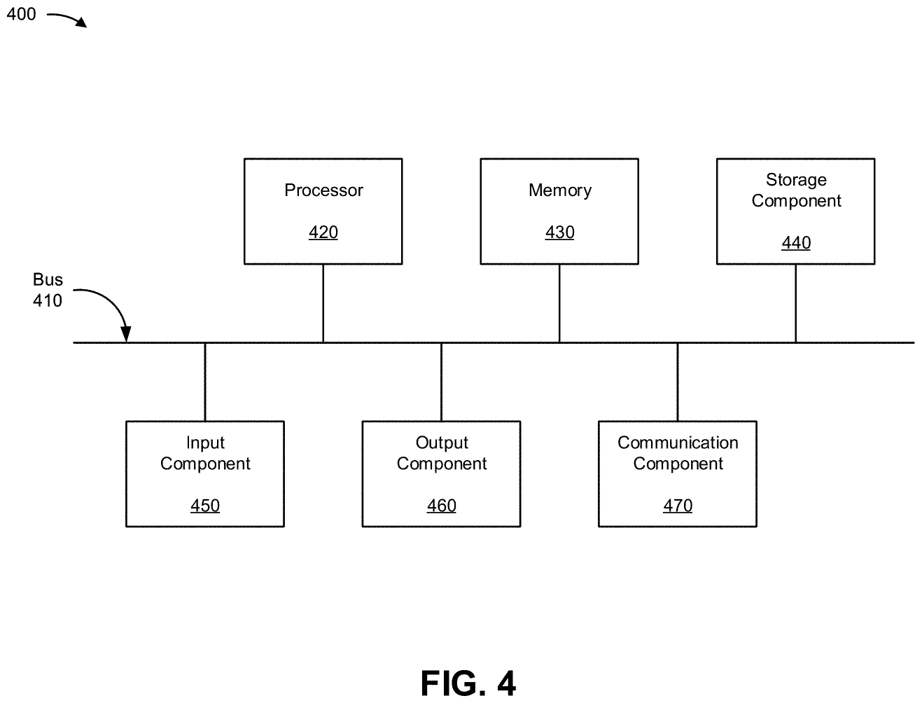

Although the planning system 301 may include one or more elements 303-313 of the cloud computing system 302, may execute within the cloud computing system 302, and/or may be hosted within the cloud computing system 302, in some implementations, the planning system 301 may not be cloud-based (e.g., may be implemented outside of a cloud computing system) or may be partially cloud-based. For example, the planning system 301 may include one or more devices that are not part of the cloud computing system 302, such as device 400 of FIG. 4, which may include a standalone server or another type of computing device. The planning system 301 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or the like, and/or a combination of these or other types of networks. The network 320 enables communication among the devices of the environment 300.

The user device 330 includes one or more devices capable of receiving, generating, storing, processing, and/or providing information, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the planning system 301 and/or the user device 330. In some implementations, the planning system 301 and/or the user device 330 may include one or more devices 400 and/or one or more components of the device 400. As shown in FIG. 4, the device 400 may include a bus 410, a processor 420, a memory 430, a storage component 440, an input component 450, an output component 460, and a communication component 470.

The bus 410 includes a component that enables wired and/or wireless communication among the components of device 400. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform a function. The memory 430 includes a random-access memory, a read only memory, and/or another type of memory (e.g., a flash memory, a magnetic memory, and/or an optical memory).

The storage component 440 stores information and/or software related to the operation of the device 400. For example, the storage component 440 may include a hard disk drive, a magnetic disk drive, an optical disk drive, a solid-state disk drive, a compact disc, a digital versatile disc, and/or another type of non-transitory computer-readable medium. The input component 450 enables the device 400 to receive input, such as user input and/or sensed inputs. For example, the input component 450 may include a touch screen, a keyboard, a keypad, a mouse, a button, a microphone, a switch, a sensor, a global positioning system component, an accelerometer, a gyroscope, an actuator, and/or the like. The output component 460 enables the device 400 to provide output, such as via a display, a speaker, and/or one or more light-emitting diodes. The communication component 470 enables the device 400 to communicate with other devices, such as via a wired connection and/or a wireless connection. For example, the communication component 470 may include a receiver, a transmitter, a transceiver, a modem, a network interface card, an antenna, and/or the like.

The device 400 may perform one or more processes described herein. For example, a non-transitory computer-readable medium (e.g., the memory 430 and/or the storage component 440) may store a set of instructions (e.g., one or more instructions, code, software code, program code, and/or the like) for execution by the processor 420. The processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

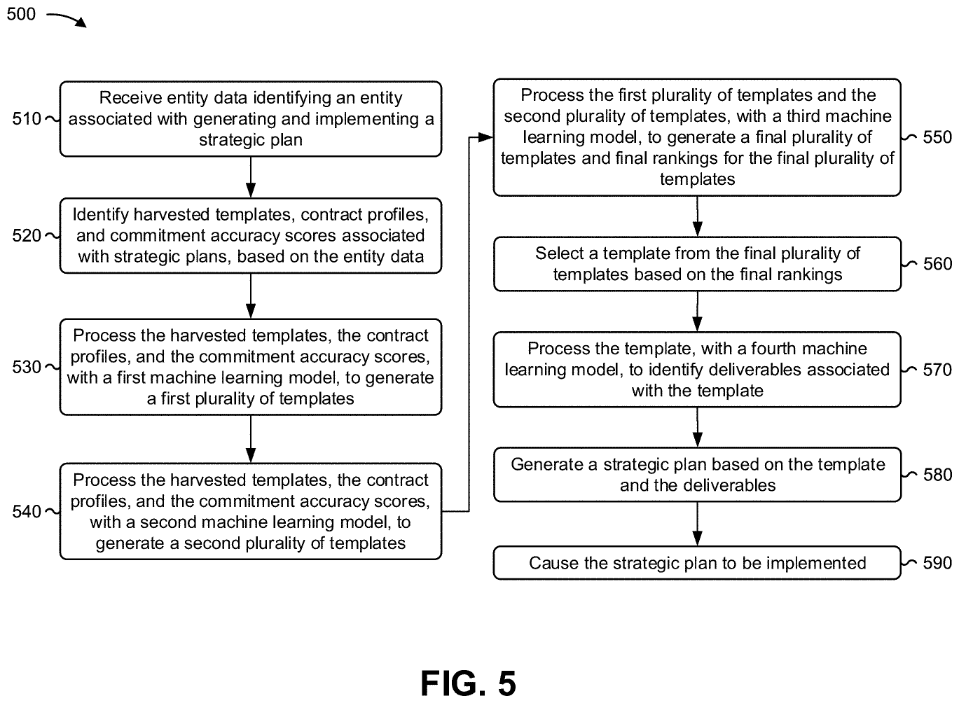

FIG. 5 is a flowchart of an example process 500 for utilizing machine learning models to generate and monitor progress of a strategic plan. In some implementations, one or more process blocks of FIG. 5 may be performed by a device (e.g., the planning system 301). In some implementations, one or more process blocks of FIG. 5 may be performed by another device or a group of devices separate from or including the device, such as a user device (e.g., the user device 330). Additionally, or alternatively, one or more process blocks of FIG. 5 may be performed by one or more components of the device 400, such as the processor 420, the memory 430, the storage component 440, the input component 450, the output component 460, and/or the communication component 470.

As shown in FIG. 5, process 500 may include receiving entity data identifying an entity associated with generating and implementing a strategic plan (block 510). For example, the device may receive entity data identifying an entity associated with generating and implementing a strategic plan, as described above.

As further shown in FIG. 5, process 500 may include identifying harvested templates, contract profiles, and commitment accuracy scores associated with strategic plans, based on the entity data (block 520). For example, the device may identify harvested templates, contract profiles, and commitment accuracy scores associated with strategic plans, based on the entity data, as described above.

As further shown in FIG. 5, process 500 may include processing the harvested templates, the contract profiles, and the commitment accuracy scores, with a first machine learning model, to generate a first plurality of templates (block 530). For example, the device may process the harvested templates, the contract profiles, and the commitment accuracy scores, with a first machine learning model, to generate a first plurality of templates, as described above. In some implementations, processing the harvested templates, the contract profiles, and the commitment accuracy scores, with the first machine learning model, to generate the first plurality of templates includes matching common factors between the harvested templates, the contract profiles, and the commitment accuracy scores, and generating the first plurality of templates based on matching the common factors between the harvested templates, the contract profiles, and the commitment accuracy scores.

As further shown in FIG. 5, process 500 may include processing the harvested templates, the contract profiles, and the commitment accuracy scores, with a second machine learning model, to generate a second plurality of templates (block 540). For example, the device may process the harvested templates, the contract profiles, and the commitment accuracy scores, with a second machine learning model, to generate a second plurality of templates, as described above. In some implementations, processing the harvested templates, the contract profiles, and the commitment accuracy scores, with the second machine learning model, to generate the second plurality of templates, includes analyzing usage patterns associated with the contract profiles, and generating the second plurality of templates based on analyzing the usage patterns associated with the contract profiles.

As further shown in FIG. 5, process 500 may include processing the first plurality of templates and the second plurality of templates, with a third machine learning model, to generate a final plurality of templates and final rankings for the final plurality of templates (block 550). For example, the device may process the first plurality of templates and the second plurality of templates, with a third machine learning model, to generate a final plurality of templates and final rankings for the final plurality of templates, as described above.

As further shown in FIG. 5, process 500 may include selecting a template from the final plurality of templates based on the final rankings (block 560). For example, the device may select a template from the final plurality of templates based on the final rankings, as described above. In some implementations, processing the first plurality of templates and the second plurality of templates, with the third machine learning model, to generate the final plurality of templates and the final rankings for the final plurality of templates includes utilizing stacked generalization to combine the first plurality of templates and the second plurality of templates, and generating the final plurality of templates and the final rankings for the final plurality of templates based on utilizing the stacked generalization to combine the first plurality of templates and the second plurality of templates.

As further shown in FIG. 5, process 500 may include processing the template, with a fourth machine learning model, to identify deliverables associated with the template (block 570). For example, the device may process the template, with a fourth machine learning model, to identify deliverables associated with the template, as described above. In some implementations, processing the template, with the fourth machine learning model, to identify the deliverables associated with the template includes determining an entity contract profile based on the entity data, and combining the entity contract profile, the template, and a deliverable knowledge data structure to identify the deliverables associated with the template. In some implementations, the first machine learning model includes a decision tree and dot product model, the second machine learning model includes a singular value decomposition and matrix factorization model, the third machine learning model includes a stacked generalization model, and the fourth machine learning model includes a cosine similarity and similarity index model.

As further shown in FIG. 5, process 500 may include generating a strategic plan based on the template and the deliverables (block 580). For example, the device may generate a strategic plan based on the template and the deliverables, as described above. In some implementations, generating the strategic plan based on the template and the deliverables includes applying the deliverables to the template to generate the strategic plan.

As further shown in FIG. 5, process 500 may include causing the strategic plan to be implemented (block 590). For example, the device may cause the strategic plan to be implemented, as described above.

Process 500 may include additional implementations, such as any single implementation or any combination of implementations described below and/or in connection with one or more other processes described elsewhere herein.

In some implementations, process 500 includes processing the strategic plan and progress data identifying progress of implementation of the strategic plan, with a fifth machine learning model, to identify milestone delays; processing the milestone delays, with a sixth machine learning model, to generate one or more recommendations to mitigate the milestone delays; and causing the one or more recommendations to be implemented.

In some implementations, causing the one or more recommendations to be implemented includes one or more of causing a task for a process of the strategic plan to be implemented to mitigate the milestone delays, causing a new deliverable to be created to mitigate the milestone delays, or identifying and causing a repetitive task to be automated to mitigate the milestone delays. In some implementations, causing the one or more recommendations to be implemented includes one or more of providing, for display, one or more alerts identifying the one or more recommendations and the milestone delays; modifying the strategic plan to mitigate the milestone delays; or retraining one or more of the first machine learning model, the second machine learning model, the third machine learning model, the fourth machine learning model, the fifth machine learning model, or the sixth machine learning model based on the one or more recommendations. In some implementations, the fifth machine learning model includes a regression model, and the sixth machine learning model includes a Euclidean distance and similarity index model.

In some implementations, process 500 includes receiving progress data identifying the progress of implementation of the strategic plan based on tracking the progress of implementation of the strategic plan, utilizing a fifth machine learning model, with the strategic plan and the progress data, to identify milestone delays, and providing data identifying the milestone delays for display.

In some implementations, process 500 includes utilizing Euclidean distance measures and the milestone delays to identify similar historic milestone delays and one or more actions taken to mitigate the similar historic milestone delays, and performing the one or more actions.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, entity data identifying an entity associated with generating and implementing a strategic plan;
identifying, by the device, harvested templates, contract profiles, and commitment accuracy scores associated with strategic plans, based on the entity data;
processing, by the device, the harvested templates, the contract profiles, and the commitment accuracy scores, with a first machine learning model, to generate a first plurality of templates;
processing, by the device, the harvested templates, the contract profiles, and the commitment accuracy scores, with a second machine learning model, to generate a second plurality of templates;
processing, by the device, the first plurality of templates and the second plurality of templates, with a third machine learning model, to generate a final plurality of templates and final rankings for the final plurality of templates;
selecting, by the device, a template from the final plurality of templates based on the final rankings;
processing, by the device, the template, with a fourth machine learning model, to identify deliverables associated with the template;
generating, by the device, a strategic plan based on the template and the deliverables; and
causing, by the device, the strategic plan to be implemented.

2. The method of claim 1, further comprising:
processing the strategic plan and progress data identifying progress of implementation of the strategic plan, with a fifth machine learning model, to identify milestone delays;
processing the milestone delays, with a sixth machine learning model, to generate one or more recommendations to mitigate the milestone delays; and
causing the one or more recommendations to be implemented.

3. The method of claim 2, wherein causing the one or more recommendations to be implemented comprises one or more of:
causing a task for a process of the strategic plan to be implemented to mitigate the milestone delays;
causing a new deliverable to be created to mitigate the milestone delays; or
identifying and causing a repetitive task to be automated to mitigate the milestone delays.

4. The method of claim 2, wherein causing the one or more recommendations to be implemented comprises one or more of:
providing, for display, one or more alerts identifying the one or more recommendations and the milestone delays;
modifying the strategic plan to mitigate the milestone delays; or
retraining one or more of the first machine learning model, the second machine learning model, the third machine learning model, the fourth machine learning model, the fifth machine learning model, or the sixth machine learning model based on the one or more recommendations.

5. The method of claim 2, wherein the fifth machine learning model includes a regression model, and the sixth machine learning model includes a Euclidean distance and similarity index model.

6. The method of claim 1, wherein processing the harvested templates, the contract profiles, and the commitment accuracy scores, with the first machine learning model, to generate the first plurality of templates comprises:
matching common factors between the harvested templates, the contract profiles, and the commitment accuracy scores; and
generating the first plurality of templates based on matching the common factors between the harvested templates, the contract profiles, and the commitment accuracy scores.

7. The method of claim 1, wherein processing the harvested templates, the contract profiles, and the commitment accuracy scores, with the second machine learning model, to generate the second plurality of templates comprises:
analyzing usage patterns associated with the contract profiles; and
generating the second plurality of templates based on analyzing the usage patterns associated with the contract profiles.

8. A device, comprising:
one or more memories; and
one or more processors, coupled to the one or more memories, configured to:
receive entity data identifying an entity associated with generating and implementing a strategic plan;
identify harvested templates, contract profiles, and commitment accuracy scores associated with strategic plans, based on the entity data;
process the harvested templates, the contract profiles, and the commitment accuracy scores, with a first machine learning model, to generate a first plurality of templates;
process the harvested templates, the contract profiles, and the commitment accuracy scores, with a second machine learning model, to generate a second plurality of templates;
process the first plurality of templates and the second plurality of templates, with a third machine learning model, to generate a final plurality of templates and final rankings for the final plurality of templates;
select a template from the final plurality of templates based on the final rankings;
process the template, with a fourth machine learning model, to identify deliverables associated with the template;
generate a strategic plan based on the template and the deliverables;
cause the strategic plan to be implemented; and
track a progress of implementation of the strategic plan.

9. The device of claim 8, wherein the one or more processors, to process the first plurality of templates and the second plurality of templates, with the third machine learning model, to generate the final plurality of templates and the final rankings for the final plurality of templates, are configured to:
utilize stacked generalization to combine the first plurality of templates and the second plurality of templates; and
generate the final plurality of templates and the final rankings for the final plurality of templates based on utilizing the stacked generalization to combine the first plurality of templates and the second plurality of templates.

10. The device of claim 8, wherein the one or more processors, to process the template, with the fourth machine learning model, to identify the deliverables associated with the template, are configured to:
determine an entity contract profile based on the entity data; and
combine the entity contract profile, the template, and a deliverable knowledge data structure to identify the deliverables associated with the template.

11. The device of claim 8, wherein the one or more processors, to generate the strategic plan based on the template and the deliverables, are configured to:
apply the deliverables to the template to generate the strategic plan.

12. The device of claim 8, wherein the one or more processors are further configured to:
receive progress data identifying the progress of implementation of the strategic plan based on tracking the progress of implementation of the strategic plan;
utilize a fifth machine learning model, with the strategic plan and the progress data, to identify milestone delays; and
provide data identifying the milestone delays for display.

13. The device of claim 12, wherein the one or more processors are further configured to:
utilize Euclidean distance measures and the milestone delays to identify similar historic milestone delays and one or more actions taken to mitigate the similar historic milestone delays; and
perform the one or more actions.

14. The device of claim 8, wherein the first machine learning model includes a decision tree and dot product model, the second machine learning model includes a singular value decomposition and matrix factorization model, the third machine learning model includes a stacked generalization model, and the fourth machine learning model includes a cosine similarity and similarity index model.

15. A non-transitory computer-readable medium storing a set of instructions, the set of instructions comprising:
one or more instructions that, when executed by one or more processors of a device, cause the device to:
receive entity data identifying an entity associated with generating and implementing a strategic plan;
identify harvested templates, contract profiles, and commitment accuracy scores associated with strategic plans, based on the entity data;
process the harvested templates, the contract profiles, and the commitment accuracy scores, with a first machine learning model, to generate a first plurality of templates;
process the harvested templates, the contract profiles, and the commitment accuracy scores, with a second machine learning model, to generate a second plurality of templates;
process the first plurality of templates and the second plurality of templates, with a third machine learning model, to generate a final plurality of templates and final rankings for the final plurality of templates;
select a template from the final plurality of templates based on the final rankings;
process the template, with a fourth machine learning model, to identify deliverables associated with the template;
generate a strategic plan based on the template and the deliverables;
cause the strategic plan to be implemented;
utilize a fifth machine learning model, with the strategic plan and progress data identifying progress of implementation of the strategic plan, to identify milestone delays;
utilize a sixth machine learning model, with the milestone delays, to generate one or more recommendations to mitigate the milestone delays; and
cause the one or more recommendations to be implemented.

16. The non-transitory computer-readable medium of claim 15, wherein the one or more instructions, that cause the device to cause the one or more recommendations to be implemented, cause the device to one or more of:
cause a task for a process of the strategic plan to be implemented to mitigate the milestone delays;
cause a new deliverable to be created to mitigate the milestone delays;
identify and cause a repetitive task to be automated to mitigate the milestone delays;
provide, for display, one or more alerts identifying the one or more recommendations and the milestone delays;
modify the strategic plan to mitigate the milestone delays; or
retrain one or more of the first machine learning model, the second machine learning model, the third machine learning model, the fourth machine learning model, the fifth machine learning model, or the sixth machine learning model based on the one or more recommendations.

17. The non-transitory computer-readable medium of claim 15, wherein the one or more instructions, that cause the device to process the harvested templates, the contract profiles, and the commitment accuracy scores, with the first machine learning model, to generate the first plurality of templates, cause the device to:
match common factors between the harvested templates, the contract profiles, and the commitment accuracy scores; and
generate the first plurality of templates based on matching the common factors between the harvested templates, the contract profiles, and the commitment accuracy scores.

18. The non-transitory computer-readable medium of claim 15, wherein the one or more instructions, that cause the device to process the harvested templates, the contract profiles, and the commitment accuracy scores, with the second machine learning model, to generate the second plurality of templates, cause the device to:
analyze usage patterns associated with the contract profiles; and
generate the second plurality of templates based on analyzing the usage patterns associated with the contract profiles.

19. The non-transitory computer-readable medium of claim 15, wherein the one or more instructions, that cause the device to process the first plurality of templates and the second plurality of templates, with the third machine learning model, to generate the final plurality of templates and the final rankings for the final plurality of templates, cause the device to:
utilize stacked generalization to combine the first plurality of templates and the second plurality of templates; and
generate the final plurality of templates and the final rankings for the final plurality of templates based on utilizing the stacked generalization to combine the first plurality of templates and the second plurality of templates.

20. The non-transitory computer-readable medium of claim 15, wherein the one or more instructions, that cause the device to process the template, with the fourth machine learning model, to identify the deliverables associated with the template, cause the device to:
determine an entity contract profile based on the entity data; and
combine the entity contract profile, the template, and a deliverable knowledge data structure to identify the deliverables associated with the template.
